(19) United States
(12) Patent Application Publication
(10) Pub. No.: US 2011/0272372 A1
(43) Pub. Date: Nov. 10, 2011

(54) SYSTEM FOR FASTENING AN ATTACHMENT PART ON MOUNTING RAILS

(75) Inventors: Ostermeier PETER, Diessen (DE); Norbert BURTSCHER, Thueringen (AT); Hermann FRITZ, Landsberg (DE)

(73) Assignee: Hilti Aktiengesellschaft, Schaan (LI)

(21) Appl. No.: 13/101,707

(22) Filed: May 5, 2011

(30) Foreign Application Priority Data
May 6, 2010 (DE) 10 2010 028 653.2

(51) Int. Cl. F16M 13/00

(52) U.S. Cl. 211/124

(57) ABSTRACT

A fastening system is disclosed. The fastening system includes a device rail, a holding element mountable on the device rail, and a supporting structure, where the supporting structure defines an opening and includes a gripping surface, and where the opening is an end of an interior space enclosed by the supporting structure. The holding element is insertable into the opening of the supporting structure and, in a back-locking position, the gripping surface grips the holding element.

This application claims the priority of German Patent Document No. 10 2010 028 653.2, filed May 6, 2010, the disclosure of which is expressly incorporated by reference herein.

### BACKGROUND AND SUMMARY OF THE INVENTION

The present invention relates to a system for fastening an attachment part to a supporting structure.

Systems for fastening an attachment part to a supporting structure are used in structural engineering to fasten attachment parts to the supporting structure. Photovoltaic modules, façade elements or lines that are part of a water heating or electrical installation are considered attachment parts. Generally speaking, support rails or mounting rails are used as supporting structures.

German Patent Document No. DE 103 13 564 A1 shows a connecting element for components. The components are provided with elongated recesses, which are aligned for accommodating the connecting elements with each other, wherein the connecting element is configured as a single-piece spring clip featuring diametrically projecting spring arms, whose width is designed for insertion in the elongated recesses, wherein an abutment section is opposite from each of the free ends of the spring arms at an axial distance, the abutment section being formed onto the spring clip and having an engagement section for an assembly tool.

A fastening element with a base plate is known from German Patent Document No. DE 10 2006 011 836 B3. Extending from the base plate are opposing first arms, each of which has a first application section at a first distance from the base plate and at least two opposing second arms, which have a second application section at a second distance from the base plate. In this case, the first arms have actuating sections, which are respectively configured as a surface having an eye.

German Patent Document No. DE 10 2007 042 484 B3 shows a device for fastening an attachment part on a supporting structure having a head part intended for bearing on the attachment part or the supporting structure, which head part has laterally protruding bearing sections. A springy front wall arrangement has two locking wings, which are aligned approximately at a right angle to the front wall. The locking wings have latching steps, which rest on the supporting structure when the device is in a back-locking position.

An insertion part for holding a sliding block in an undercut profile groove of a profile strip is known from German Patent Document No. DE 20 2005 003 224 U1. In an inserted state, the insertion part has the same longitudinal axis that is essentially parallel to a strip axis of the profile strip, wherein the insertion part has a seat for the sliding block with axially opposing seat limiting surfaces, between which the sliding block can be accommodated, as well as bearing surfaces arranged between the seat limiting surface for supporting the sliding block. In this case, the insertion part has first supporting surfaces, which, when the inserted part is in the inserted state, allow the same to be supported on undercut surfaces of the profile groove, wherein at least one portion of the first supporting surfaces is arranged to be flexibly deflectable in such a way that the insertion part can be inserted through the groove opening of the profile groove into same.

German Patent Document No. DE 20 2006 018 426 U1 shows a mounting rail system for holding objects, in particular planar bodies, such as solar modules or solar collectors, wherein there is at least one rail-like profile having at least two profile strips running in the longitudinal direction of the rail-like profile and at least one spring-elastic clamp element for fastening the rail-like profile on a substrate and/or for holding objects on the rail-like profile having at least two opposing spring legs engaging on opposing sides of the rail-like profile, which cooperate respectively with one of the profile strips in such a way that the spring-elastic clamp element can be secured spring-elastically on the rail-like profile.

The object of the present invention is making a system available in which attachment parts may be fastened without tools on a supporting structure by the system with a simple technical design. In addition, the system is inexpensive to manufacture and makes simple and reliable handling possible.

This objective is attained with a system for fastening an attachment part on at least one supporting structure by at least one device with at least one moveable holding element, which holding element or which device during insertion into an opening of the supporting structure is moveable into a pre-engagement position because of a contact between the at least one holding element and the supporting structure and is moveable into a back-locking position by a reverse movement of the at least one holding element after insertion into the opening in such a way that the supporting structure can be gripped behind by the at least one holding element on a gripping surface for a form-fitting and/or force-fit connection between the at least one holding element and the supporting structure and at least securing device for securing the attachment part on the at least one device, at least one supporting structure, wherein the device comprises at least one elastic element and the at least one holding element is moveable by the at least one elastic element from the pre-engagement position into the back-locking position and/or the supporting structure features the opening and the opening is an end of an interior space enclosed by the supporting structure, in particular a support groove, and/or the gripping surface is provided with several longitudinal grooves for gripping behind with the at least one moveable holding element and/or the supporting structure is configured with the gripping surface and, in the back-locking position, the at least one holding element grips behind the gripping surface in a form-fitting manner.

In particular, the at least one holding element is configured as the elastic element. The at least one holding element and the elastic element or the at least one elastic element thus form a component so that only one component must be manufactured or reserved for the holding element and the elastic element.

In another embodiment, the elastic element is configured as a leaf spring. A leaf spring is inexpensive to manufacture and simple to fasten on the device rail of the device.

In a supplementary embodiment, the leaf spring is configured with at least one locking arm for engaging on the gripping surface and/or the at least one locking arm is engaged on the gripping surface.

The at least one holding element, in particular the leaf spring, is preferably fastened in a form-fitting and/or force-fit manner on the at least one device.

In one variant, the at least one device comprises a device rail and/or the at least one device comprises a supporting plate or a grate as the securing device for securing the attachment part on the at least one device. The device rail may be an aluminum or zinc die casting, but it is preferably an extruded section and therefore especially inexpensive to manufacture. In the present case, the term “device rail” should not be understood restrictively to the effect that this component must be understood to be longer than wide in terms of its expansion; in fact, this term also includes components that can be wider than they are long.

The device rail expediently has at least one hollow space in the longitudinal direction of the device rail.

A device web with a shoulder is expediently configured on the at least one device, in particular under the supporting plate, and the leaf spring has a holding tongue, which grips behind the shoulder on the device and/or a device groove is configured on the at least one device, in particular between the supporting plate and the device web, and/or a device slot is configured on the at least one device, in particular the device web, and the leaf spring engages in the device slot.

In a further embodiment, several holding elements are fastened on the device in the longitudinal direction and/or the at least one holding element, in the back-locking position, is arranged at least partially, in particular completely, in an interior space enclosed by the supporting structure, in particular the support groove, and/or a force-fit and/or form-fitting connection can be produced or exists between the at least one holding element and the supporting structure.

In particular, the gripping surface is configured as an essentially flat surface.

In another embodiment, a support web is configured on the supporting structure and the support web partially limits the interior space, in particular the support groove, and, in the back-locking position, the support web is arranged in the device groove.

In a supplementary variant, in the back-locking position, the support web rests on the device, in particular on the supporting plate.

In another variant, the supporting structure is a support rail or a mounting rail.

In another embodiment, the system has two, in particular identical, supporting structures and the two supporting structures are aligned essentially parallel to each other and the openings of the interior spaces of the two supporting structures are preferably aligned in the same direction.

In particular, at least one device is fastened on each of the two supporting structures, and preferably at least two devices are fastened on each of the two supporting structures, however, embodiments are also possible in which three or more supporting structures are used.

In another embodiment, the elastic element is pre-stressed in the back-locking position.

In an additional embodiment, the at least one securing device comprises the supporting plate or the grate for preferably direct securing of the device on the attachment part.

In another embodiment, the supporting structure and/or the device and/or the device rail and/or the supporting plate and/or the at least one holding element and/or the at least one elastic element is/are made at least partially, in particular completely of metal, e.g., aluminum or steel or stainless steel, and/or of plastic.

In another embodiment, the device can be fastened on the supporting structure by a snap-in and/or latching mechanism, e.g., the elastic element.

In a supplementary embodiment, the at least one elastic element is not pre-stressed in a pre-engagement position.

In another embodiment, the at least one securing device comprises an adhesive, latch, rivet and/or screw connection for securing the attachment part on the device, in particular the supporting plate.

In a supplementary embodiment, the opening is an assembly opening for fastening the device on the supporting structure.

Exemplary embodiments of the invention will be described in greater detail in the following making reference to the drawings.

### BRIEF DESCRIPTION OF THE DRAWINGS

FIG. 1 is a cross-section of a system in a final assembled state;

FIG. 2 is a cross-section of a supporting structure in a first exemplary embodiment;

FIG. 3 is a cross-section of the supporting structure in a second exemplary embodiment;

FIG. 4 is a cross-section of a device rail of a device;

FIG. 5 is a first perspective view of a leaf spring of the device;

FIG. 6 is a second perspective view of the leaf spring of the device;

FIG. 7 is a perspective view of the device with two leaf springs;

FIG. 8 is a cross-section of the device with the attachment part and the supporting structure in a first pre-assembly position;

FIG. 9 is a cross-section of the device with the attachment part and the supporting structure in the second pre-assembly position; and

FIG. 10 a cross-section of the device without the attachment part and the supporting structure in a final assembled position with the leaf spring in a back-locking position.

### DETAILED DESCRIPTION OF THE DRAWINGS

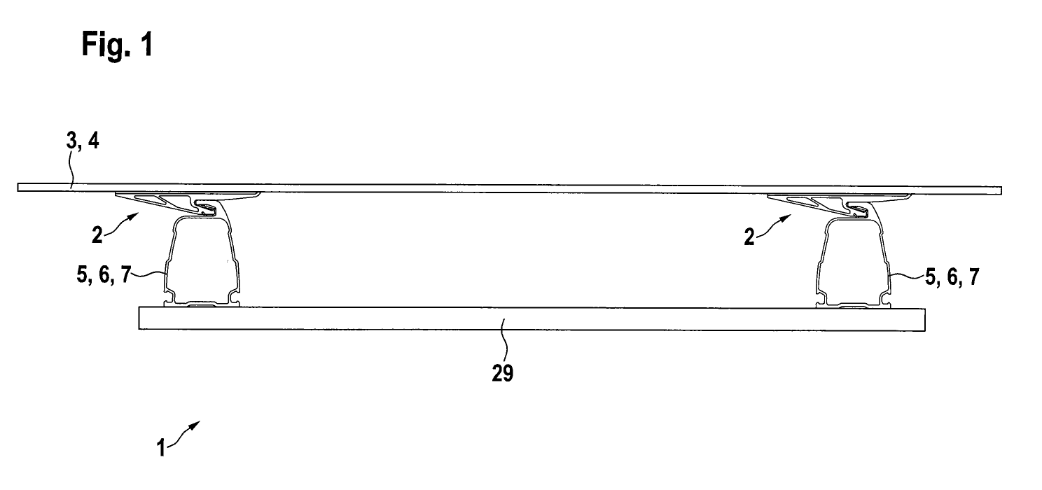

Systems 1 with devices 2 for fastening an attachment part 3 on a supporting structure 5 are used in structural engineering or in the construction industry. The attachment part 3 in this case is, for example, a photovoltaic module 4, a façcade element or a line (not shown) and the supporting structure 5 is a support rail 6 or a mounting rail 7. The two mounting rails 7 depicted in FIG. 1 are fastened parallel to one another on a mounting base 29. As a result, the device 2 can be used to fasten the attachment part 3 indirectly on the supporting structure 5.

The device 2 in this case comprises a device rail 31 with a supporting plate 26 as a securing device 25 for securing the attachment part 3 on the device 2. The fastening surface 30 of supporting plate 26 is connected to the attachment part 3 (FIGS. 1, 8 and 9), for example, by adhesion or welding, or in a form-fitting manner, for example using screws or rivets (not shown) for producing a screwed or riveted joint. The height of the ramp 28 of the supporting plate 26 is less than the height of the layer thickness of an adhesive that is possibly used for fastening the attachment part 3 on the device rail 31 (not shown).

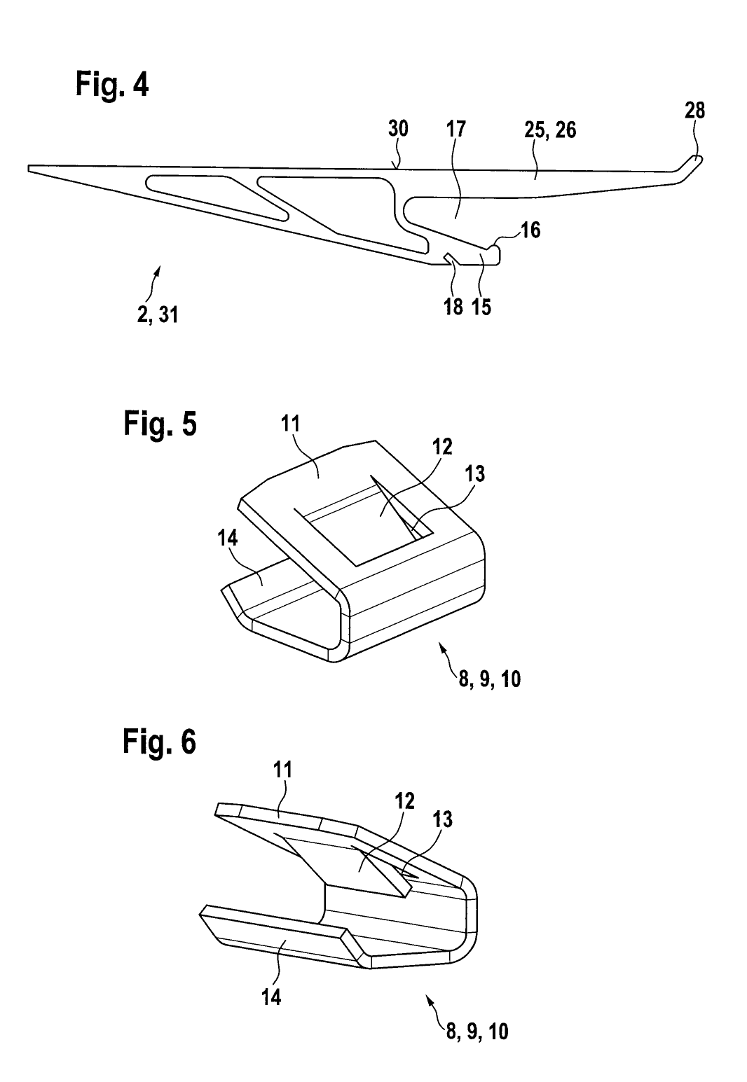

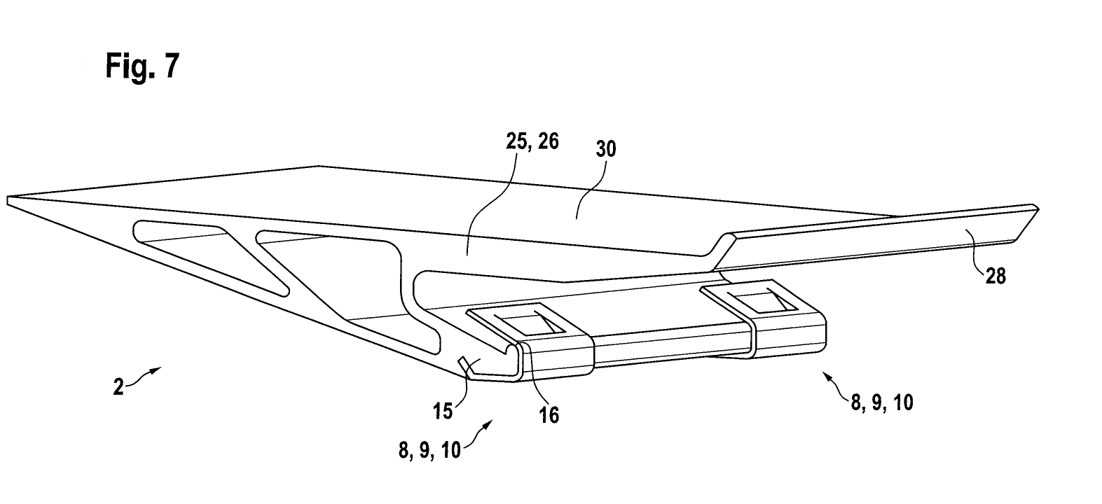

There is a device web 15 (FIGS. 4, 7 and 8) on the device rail 31 on the surface of the supporting plate 26 opposite from the fastening surface 30. The device web 15 together with the supporting plate 26 encloses a device groove 17. A shoulder 16 is configured at the end of the device web 15 and, in addition, there is a device slot 18 on the underside on the device web 15 (FIGS. 4 and 7). A ramp 28 on the end of the supporting plate 26 is used as an assembly aid when sliding the device rail 31 onto the mounting rail 7. The device rail 31 is one-piece and preferably manufactured inexpensively by extrusion (FIGS. 4 and 7). Two holding elements 8 are fastened on the device web 15 of the device rail 31 (FIG. 7). The holding elements 8 in this case constitute elastic elements 9 configured as leaf springs 10 (FIGS. 5 and 6). The leaf springs 10 have a leaf spring cut-out 13 with a holding tongue 12 and a locking arm 11. Furthermore, a leaf spring chamfer 14 is also configured on the leaf spring 10. To fasten the leaf springs 10 to the device web 15, the leaf springs 10 are slid with a rear end of the locking arm 11 onto the device web 15 so that the holding tongue 12 grips behind the shoulder 16 on the device web 15 and the leaf spring chamfer 14 is also arranged in the device slot 18 (FIG. 7). As a result, the leaf spring 10 is fastened in a form-fitting and force-fit manner on the device web 15 of the device rail 31.

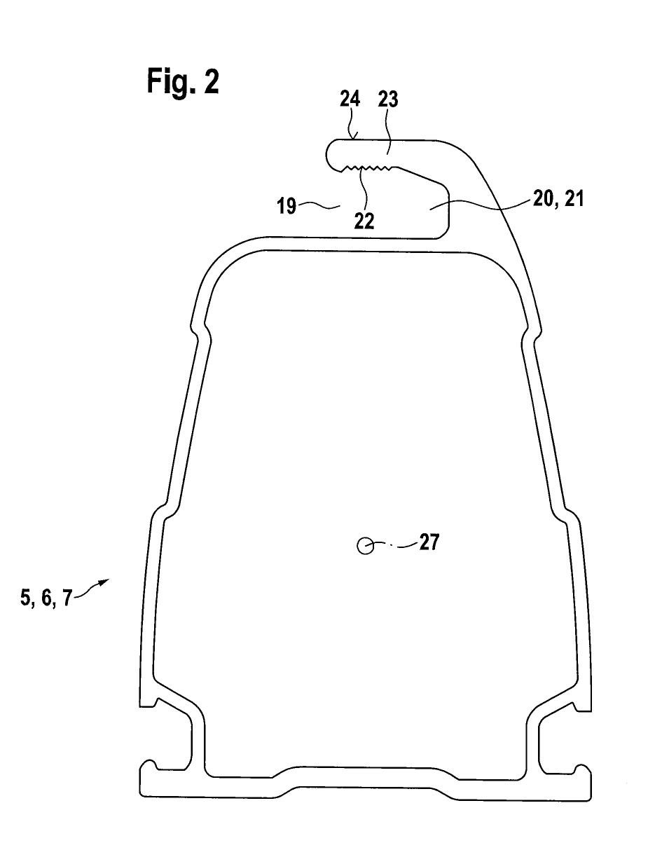

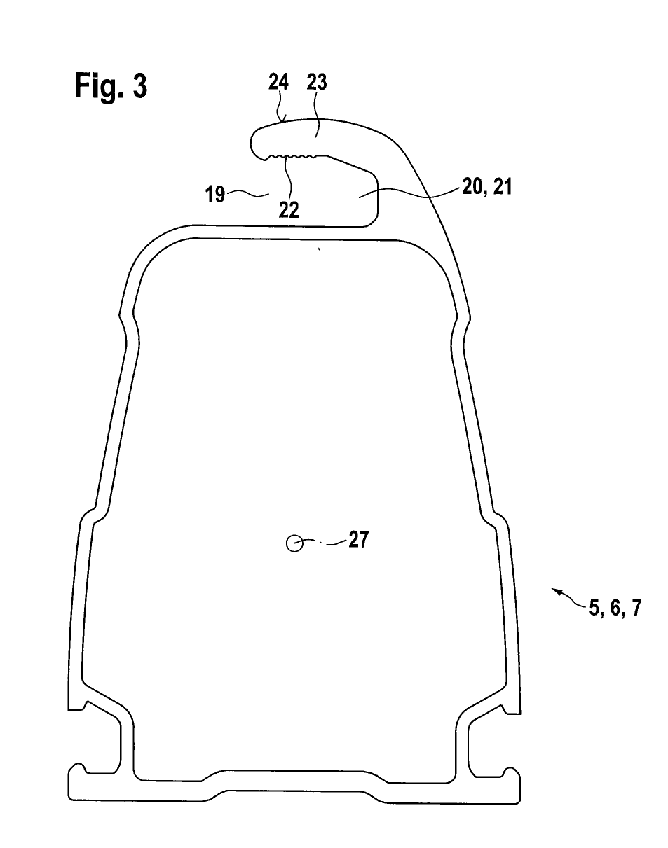

The mounting rail 7 (FIGS. 2 and 3) is also an extruded section and has a support web 23. There is a bearing surface 24 for the supporting plate 26 on the upper side of the support web 23. The bearing surface 24 in this case may be configured to be flat (FIG. 2) or curved (FIG. 3). With a curved or arch-shaped formation of the bearing surface 24 of the support web 23, the supporting plate 26 is mounted on the bearing surface 24 in an articulated manner. As a result, any imprecision in the installation may be equalized and tensions in the adhesion between the attachment part 3 and the device 2 can be dissipated better. The latter is of particular interest in the case of very fragile photovoltaic modules 4. The support web 23 together with a remaining part of the mounting rail 7 encloses an interior space 20, which has an opening 19. The interior space 20 in this case is configured as a support groove 21 and has a substantially greater expansion parallel to a rail longitudinal axis 27, for example greater by at least 2, 5 or 10 times, than perpendicular to the rail longitudinal axis 27. The rail longitudinal axis 27 in this case is perpendicular on the plane of projection of FIGS. 2 and 3. A gripping surface 22 is configured on the support web 23 on the side facing the interior space 20. The gripping surface 22 here is provided with longitudinal grooves parallel to the rail longitudinal axis 27. Thus, there are teeth or latches on the gripping surface 22, which can grip behind the locking arm 11 of the leaf spring 10. In this case, the first tooth or latch depicted on the left in FIGS. 2 and 3 is higher than the remaining teeth or latches, as viewed in the direction of the interior space 20.

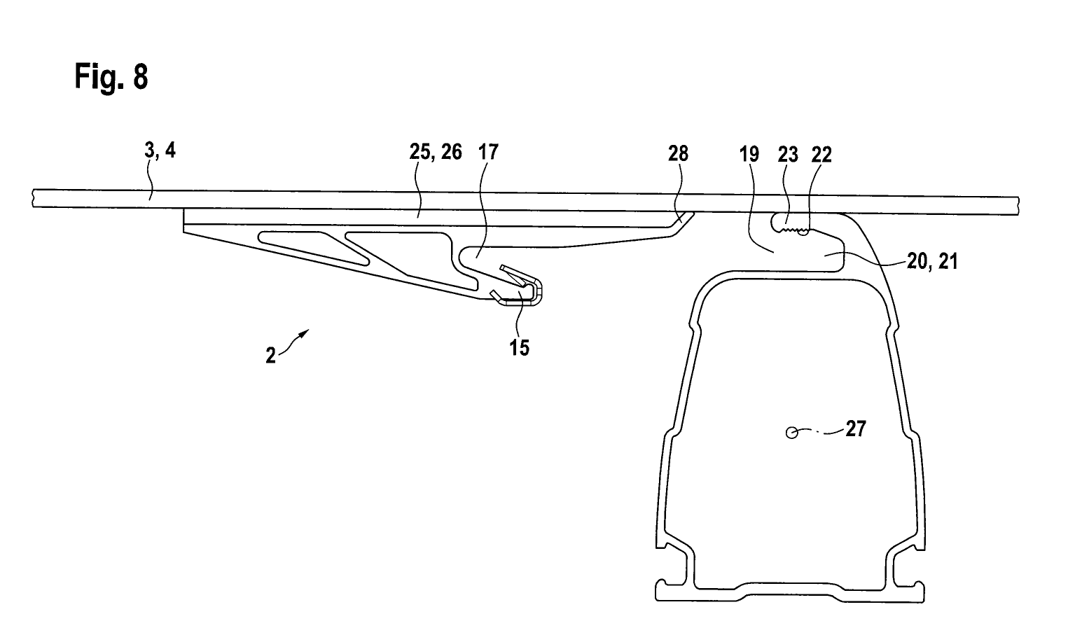

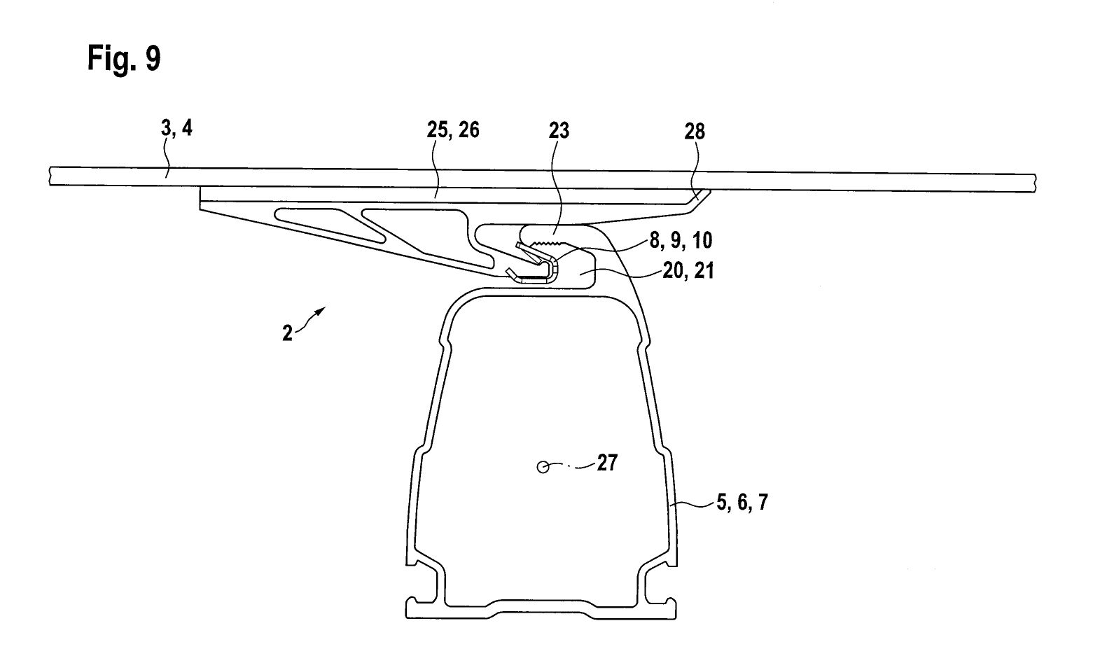

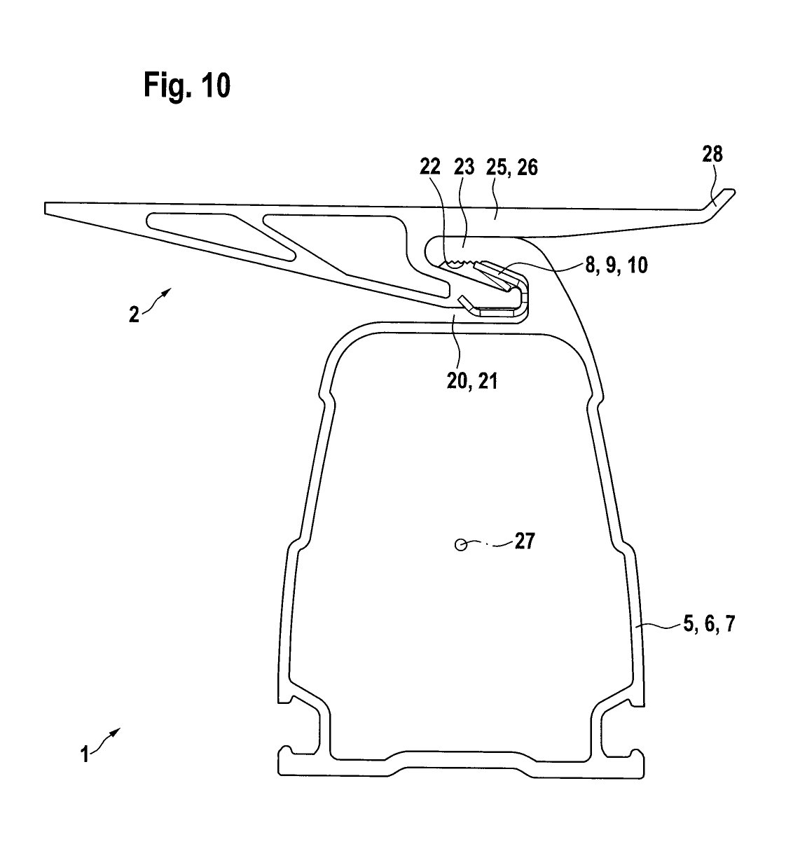

FIG. 8 depicts a first pre-assembly position of the device 2 on the mounting rail 7, FIG. 9 shows a second pre-assembly position and FIG. 10 depicts a final assembled position. In the first pre-assembly position, the attachment part 3 as a photovoltaic module 4 rests on the bearing surface 24 of the support web 23 and the ramp 28 of the supporting plate 26 is arranged at a distance from the support web 23. In the first pre-assembly position, the locking arm 11 of the leaf spring 10 is not pre-stressed in a pre-engagement position. When moving the device 2 with the attachment part 3 further to the right towards the mounting rail 7, the ramp 28 of the supporting plate 26 comes to rest laterally on the support web 23 of the mounting rail 7 (not shown) and because of the ramp shape, the supporting plate 26 is moved above the support web 23 so that supporting plate 26 rests on the support web 23 and the support web 23 is inserted into the device groove 17 of the device rail 31 so that the support web 23 is situated in the device groove 17. As a result, the supporting plate 26 rests on the bearing surface 24 of the support web 23 and the locking arm 11 of the leaf spring 10 abuts the forwardmost and largest tooth or locking arm of the gripping surface 22 configured on the support web 23 (FIG. 9). In this second pre-assembly position, the device 2 may be moved perpendicular to the plane of projection of FIG. 9, i.e., parallel to the rail longitudinal axis 27. This makes readjustment or precision adjustment of the attachment part 3 on the two mounting rails 7 possible. Once this precision adjustment of the attachment part 3 relative to the two mounting rails 7 is complete, a sufficiently great force is applied to the device 2 and/or the attachment part 3 so that the locking arm 11 of the leaf spring 10 is moved far enough downward against the pre-stressing force of the locking arm 11 (according to the depiction in FIG. 9) so that the locking arm 11 grips behind the outermost tooth. With a further movement of the attachment part 3 with the device 2 in the direction of the interior space 20 of the mounting rail 7, the locking arm 11 engages in the subsequent latches of the gripping surface 22. As a result, the device 2 is fastened in a form-fitting and force-fit manner with a snap-in connection on the mounting rail 7. In the final assembled state in accordance with the depiction in FIG. 10, the locking arm 11 of the leaf spring 10 is therefore situated in a back-locking position and is pre-stressed in the process.

The locking arm 11 in this case can be engaged in different latches of the gripping surface 22 so that it is thereby possible to equalize the distance between the two mounting rails 7, for example due to manufacturing tolerances or any imprecision in the assembly of the overall structure.

The leaf springs 10 depicted in FIGS. 5 and 6 do not have tabs on the locking arms 11. As a result, after inserting the device 2 into the final assembled position and gripping behind the gripping surface 22 with the locking arm 11 of the leaf springs 10, it is not possible to detach the locking arms 11 again from the back-locking position and thereby remove the attachment part 3 with the device 2 from the two mounting rails 7. This facilitates theft protection. Deviating herefrom (not shown), there can be a lateral tab on each of the two locking arms 11 of the leaf spring 10 so that an auxiliary tool or special tool can be used to move the locking arms 11 out of engagement with the gripping surface 22, thereby making it possible to remove the device 2 with the attachment part 3 from the mounting rail 7 again.

As a result, the present system can be used to fasten, for example, an essentially rectangular photovoltaic module 4 on the corner regions with four or more devices 2. A device 2 is thus arranged on the photovoltaic module 4 in each of the two upper corner regions and the devices are fastened on the upper mounting rail 7 (FIG. 1), and a device 2 is likewise arranged on each of the two lower corner regions of the photovoltaic module 4 and the devices are fastened on the lower mounting rail 7 (FIG. 1).

Considered as a whole, the system 1 according to the invention is associated with substantial advantages. Fastening attachment parts 3 to supporting structures 5 can be accomplished in a structurally simple manner. As a result, costs may be saved in manufacturing the device 2 and the system 1 and, because of the lack of pre-stressing the leaf springs 10 in the pre-assembly position, no unintentional movement or release of the holding elements 8 as leaf springs 10 develops. Thus, in the pre-assembly state, no damage to the device 2 or the system 1 is incurred on the device 2 from slight forces acting on the device 2.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fastening system, comprising:
a device rail;
a holding element mountable on the device rail; and
a supporting structure, wherein the supporting structure defines an opening and includes a gripping surface and wherein the opening is an end of an interior space enclosed by the supporting structure;
wherein the holding element is insertable into the opening of the supporting structure and wherein in a back-locking position, the gripping surface grips the holding element.

2. The system according to claim 1, wherein the holding element is moveable into a pre-engagement position as a result of contact between the holding element and the supporting structure.

3. The system according to claim 1, wherein the holding element is a leaf spring.

4. The system according to claim 3, wherein the leaf spring includes a locking arm that is engageable on the gripping surface.

5. The system according to claim 3, wherein the leaf spring is fastenable on the device rail.

6. The system according to claim 1, wherein the device rail includes a supporting plate.

7. The system according to claim 6, wherein the device rail includes a device web with a shoulder disposed under the supporting plate and wherein the holding element includes a holding tongue which is grippable with the device rail behind the shoulder

8. The system according to claim 6, wherein the device rail includes a groove defined between the supporting plate and a device web of the device rail.

9. The system according to claim 1, wherein the device rail includes a slot defined on a device web of the device rail and wherein the holding element is engageable in the slot.

10. The system according to claim 1, wherein a plurality of holding elements are fastenable on the device rail in a longitudinal direction

11. The system according to claim 1, wherein the holding element, in the back-locking position, is arranged completely or at least partially in an interior space enclosed by the supporting structure.

12. The system according to claim 1, wherein the gripping surface is configured as an essentially flat surface.

13. The system according to claim 1, wherein the supporting structure includes a support web and the support web partially limits an interior space of the supporting structure and wherein in the back-locking position, the support web is arranged in a groove defined by the device rail.

14. The system according to claim 13, wherein in the back-locking position, the device rail rests on the support web.

15. The system according to claim 1, wherein the supporting structure is a support rail or a mounting rail.

16. The system according to claim 1, wherein the holding element is pre-stressed in the back-locking position.

17. The system according to claim 1, wherein the holding element is elastic such that the holding element is moveable from a pre-engagement position into the back-locking position via the elastic.
